(19) United States
(12) Patent Application Publication
(10) Pub. No.: US 2009/0106095 A1
(43) Pub. Date: Apr. 23, 2009

(54) Navigator With Dataform Decoder

(75) Inventors: Yiwu Ding, Arlington, TX (US); William H. Havens, Syracuse, NY (US); Ynjiun P. Wang, Cupertino, CA (US)

Correspondence Address: HAND HELD PRODUCTS, INC., 700 VISIONS DRIVE, P.O. BOX 208, SKANEATELES FALLS, NY, 13153-0208, US

(73) Assignee: HAND HELD PRODUCTS, INC., Skaneateles Falls, NY (US)

(21) Appl. No.: 11/876,333

(22) Filed: Oct. 22, 2007

(51) Int. Cl. G01C 21/34; G01C 21/00; G06Q 30/00

(52) U.S. Cl. 705/14; 701/200; 701/201; 701/209

(57) ABSTRACT

A navigation system based on a web server that provides a client with a map of a destination having an associated dataform encoding an indication of the destination. A navigator is provided that includes a GPS receiver receiving signals from one or more satellites, a memory storing navigational data, a dataform reader that extracts a destination from the dataform, and a processor that calculates a route to the destination extracted by the dataform reader.

### BACKGROUND OF THE INVENTION

Route planning devices, often called navigators, are well known in the field of navigational instruments. Navigators, offered by companies such as HORIZON NAVIGATION, Inc., GARMIN, Ltd., and TOMTOM International, generally comprise a hand-held or dash mounted unit that displays a map of a driver's location and provides graphic and audio cues to assist the driver with navigating to a desired destination.

FIG. 1 is a block diagram of a known Navigator 100. In particular FIG. 1 is derived from U.S. Pat. No. 7,062,378 incorporated herein by reference. The Navigator 100 generally includes a processor 110 which is connected to a touchpad 120; a memory 130; display screen 140; a GPS receiver 150; and I/O ports 160. In use, the processor 110 determines a starting location using the GPS receiver 150 and receives a destination from a user via entry on the touch pad 120. Using geographical and routing data stored in memory 130, the processor 110 calculates a route from the current location to the destination. As the user of the navigator 100 moves, the processor will continually update the current location using data from the GPS receiver 150 and advise the user of upcoming course corrections, such as turns. Additional geographic and routing data/logic may be uploaded to the navigator 100 via the I/O port 160.

As may be appreciated, the major user interaction with a navigator 100 comprises inputting a destination. Current navigation systems provide a variety of methods to input a destination, all of which require extensive user interaction with the navigator—using either key presses or touch pad taps. Generally, a user will press alpha-numeric virtual buttons on the touch pad 120. Using addresses in the United States as an example, a typical system has a user first selecting a state from a drop down list followed by a city from another drop down list. Subsequently, the user will type in a number followed by a street name. Many systems provide an auto-complete function that suggests street names based on the already selected letters. The foregoing entry systems may be adequate for some users, but in general are quite awkward and frustrating for many users, such as those whose native language is different than the input language of the navigator, poor spellers, and those with an aversion to technology. It is also a headache to figure out how to navigate the different systems for users of multiple systems (such as with car rental systems). For example, different generations of navigators may use different input methods—not to mention different lines and brands of navigators. Accordingly, the present inventors have recognized a need for an alternative method for entering destination data in a navigator.

### BRIEF DESCRIPTION OF THE DRAWINGS

An understanding of the present invention can be gained from the following detailed description of the invention, taken in conjunction with the accompanying drawings of which:

FIG. 1 is a block diagram of a known Navigator.

FIG. 2 is a block diagram of a navigator in accordance with an embodiment of the present invention.

FIG. 3 illustrates a navigation system suitable for use with the navigator illustrated in FIG. 2.

FIG. 4 illustrates a sample printed sheet suitable for use with the navigation system illustrated in FIG. 3.

### DETAILED DESCRIPTION

Reference will now be made in detail to the present invention, examples of which are illustrated in the accompanying drawings, wherein like reference numerals refer to like elements throughout. The following description will use nomenclature associated with an imager based barcode reader, however those of ordinary skill in the art will recognize that the present invention is applicable to a variety of dataform readers including RF or magnetic stripes; barcodes; and the like. It is anticipated that many such portable devices would benefit from the present invention, including the embodiments thereof described herein.

A method is here, and generally, conceived to be a sequence of steps or actions leading to a desired result and may be implemented as software. While it may prove convenient to discuss such software as if were embodied by a single program, most implementations will distribute the described functions among discrete (and some not so discrete) pieces of software. These pieces are often described using such terms of art as “programs,” “objects,” “functions,” “subroutines,” “libraries,” “.dlls,” “APIs,” and “procedures.” While one or more of these terms may find favor in the present description, there is no intention to limit the invention to the described configurations.

With respect to software described herein, those of ordinary skill in the art will recognize that there exist a variety of platforms and languages for creating software for performing the methods outlined herein. Embodiments of the present invention can be implemented using MICROSOFT VISUAL STUDIO or any number of varieties of C. However, those of ordinary skill in the art also recognize that the choice of the exact platform and language is often dictated by the specifics of the actual system constructed, such that what may work for one type of system may not be efficient on another system. It should also be understood that the methods described herein are not limited to being executed as software on a computer or DSP (Digital Signal Processor), but can also be implemented in a hardware processor. For example, the methods could be implemented with HDL (Hardware Design Language) in an ASIC.

In the present description, an element number followed by a letter generally indicates multiple occurrences of similar, either in structure or function, elements. Further, the use of an italicized “n” (e.g. n) associated with an element number generally denotes either an unspecified one of such elements or a partial or complete group of such elements—the meaning of which is to be drawn from the context of such use.

FIG. 2 is a block diagram of a navigator 200 in accordance with an embodiment of the present invention. Those of ordinary skill in the art will recognize that the illustrated design of the navigator 200 has been simplified so as to permit a briefer explanation of systems and components not directly related to the present invention.

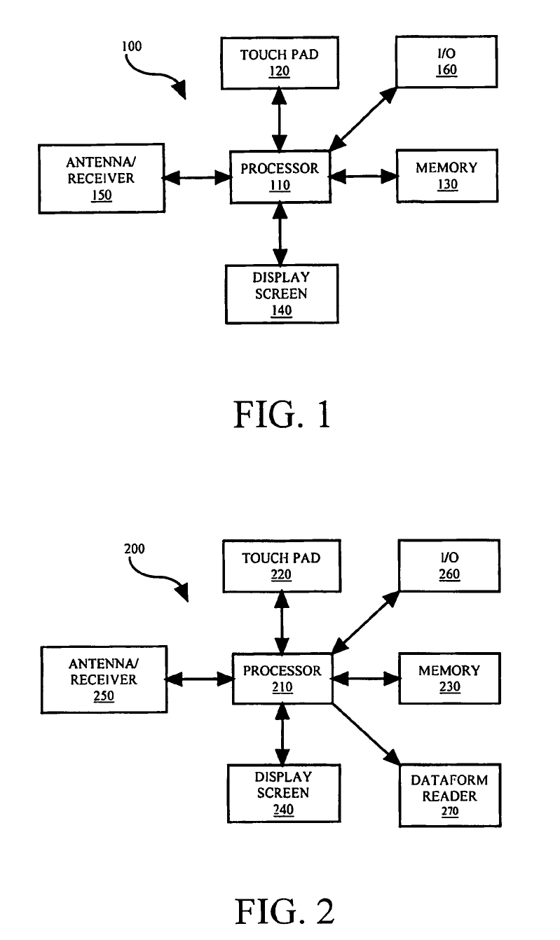

The navigator 200 is generally similar to the navigator 100 illustrated in FIG. 1 with the addition of a datform reader 270 capable of decoding a suitable symbology. The dataform reader may, for example, comprise a barcode scanner or image based system, such as any of the HAND HELD PRODUCTS ADAPTUS line of imagers. A variety of suitable symbologies may be utilized in accordance with the present invention, including any number of 1-D, stacked and 2-D symbols. For example, embodiments of the present invention may be implemented using the AZTEC 2-D symbology.

In operation, the dataform reader 270 reads a dataform, such as a barcode, that contains an indication of a destination. This destination is utilized by the navigator 200 for route calculation. Many barcode readers, such as the HAND HELD PRODUCTS ADAPTUS line of imagers are provided in module form including decoding hardware and algorithms. The output of such units typically comprises an ASCII string. Thus, by encoding the barcode with a text string that matches the input a user would otherwise supply via the touch pad 220 integration of a dataform reader within existing navigation systems is simplified.

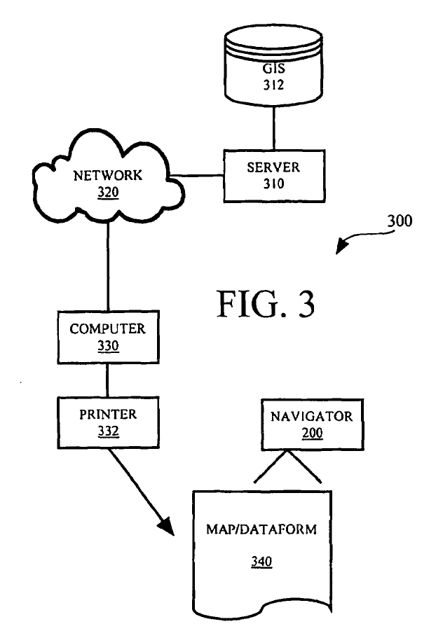

FIG. 3 illustrates a navigation system 300 suitable for use with the navigator 200 illustrated in FIG. 2. The navigation system 300 includes a server 310 connected to a geographical information system (GIS) 312. As is known to those of ordinary skill in the art, the GIS 312 may physically reside on the server 310. The hardware portion of the server 310 may be selected from a variety of vendors, including DELL, IBM, and HP. The server 310 also includes web server software, such as APACHE or WEBSPHERE. The GIS 312 may comprise a geographical database and routing software such as those available from ESRI and TELE ATLAS. Examples of suitable routing software include the ESRI ArcIMS with a route server extension. Other examples of map and route calculation systems that may be easily modified for use in accordance with embodiments of the present invention include GOOGLE MAPS (especially with the use of GOOGLE MAP hacks), MAPQUEST, and MICROSOFT MAPS.

The server 310 serves maps and optional routing information to one or more computers 330 running any number of readily available web browsers such as EXPLORER or FIREFOX. In use, the user redirects his browser to a URL served by the server 310. The server 310 presents the user with a web page into which the user enters a destination by way of an address, zip code, intersection, latitude and longitude, etc . . . The server 310 accesses the GIS 312 to obtain map data and optional routing data. Using this data, the server generates a web page including a map, a dataform containing an indication of the destination, and, optionally, directions and points of interest or advertisements.

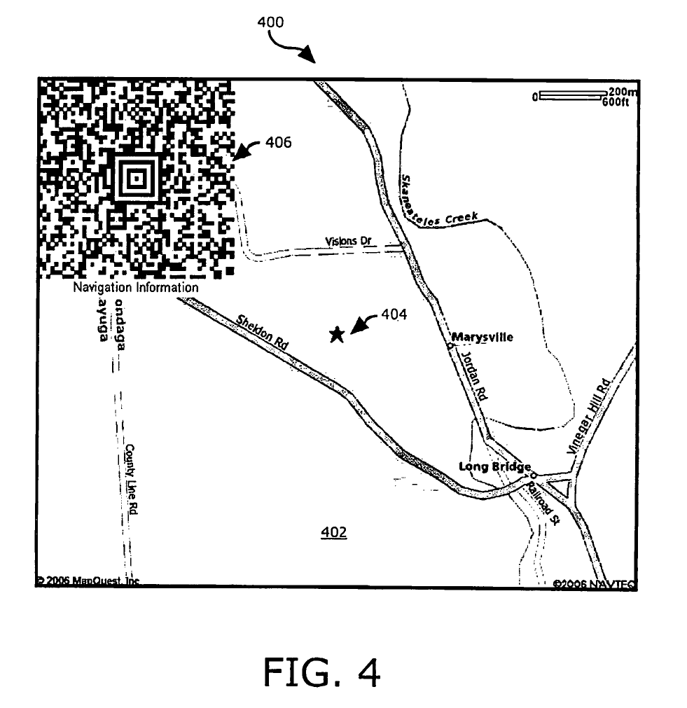

FIG. 4 illustrates a sample printed sheet suitable for use with the navigation system 300 illustrated in FIG. 3. The sheet 400 generally comprises a map 402 of an area surrounding the destination 404 (typically highlighted with a symbol such as a star) and a dataform 406, such as a barcode, that contains an indication of the destination. The dataform 406 may also include a variety of additional data, including desired waypoints (so as to induce a particular route) and points of interest. In the example illustrated in FIG. 4, the dataform 406 is an AZTEC code that contains the data shown in TABLE 1.

TABLE 1

Hand Held Products
700 Visions Dr.
Skaneateles Falls
NY 13153
FOOD
Sherwood Inn
26 W. Genesee Street
Skaneateles, NY 13152
(315) 685-3405
Bluewater Grill and Sweetwater Café
11 W. Genesee Street
Skaneateles, NY 13152
(315) 685-6600

Once a suitable map has been displayed on a screen of the computer 330, the user prints the map and dataform on a printer 332 thereby producing a print out 340. The printout 340 is then carried by a traveler to the navigator 200 generally located in an automobile. Once the traveler is situated and ready to proceed, he simply starts up the navigator and guides the user interface of the navigator 200 to a destination entry screen and scans the dataform 406 (it is to be recognized that any suitable dataform may be utilized) with the dataform reader 270 of the navigator 200. Once the destination information (and any waypoints and points of interest) have been entered into the navigator 200, operation thereof generally proceeds in accordance with the operation of known navigators.

Although some embodiments of the present invention have been shown and described, it will be appreciated by those skilled in the art that changes may be made in these embodiments without departing from the principles and spirit of the invention, the scope of which is defined in the claims and their equivalents. For example, an RFID tag could be substituted for the dataform 406. A simple passive RFID tag can be printed by appropriate printers and integrated with the printout 400. In this case, the dataform reader 270 would comprise an RFID scanner.

Also while the navigator 200 has been described as being based on off-the shelf navigators by such suppliers as GARMIN, the navigator 200 may comprise a cell phone equipped with mapping and routing software, such as that available from GOOGLE and NOKIA. Most cell phones now include an imager that may be capable of taking an image of a barcode sufficient for decoding.

By way of another example, the dataform may be displayed as an image on a cell phone. This image can be presented to the navigator 200 for scanning. In this example, the dataform for any given destination may be retrieved using the internet browsing capability of many cell phones or it may be sent to the cell phone as a message. In yet another example, the dataform may be printed on a business card, letterhead or other advertisement.

By way of another example, points of interest other than a destination may be associated with the screens and printouts utilized by a user of the navigation system 300. One example of points of interest might be the attractions, hotels and restaurants in vicinity of the travel destination entered by the user. Advertisements for such points of interests, including addresses, admittance codes, gift certificate code and/or coupon codes, may also be encoded into the dataform 406 or into separate dataforms on the printout 340. On the navigator 200, indications of locations associated with such advertisements may be automatically displayed or they may be accessed using buttons (hard, soft or virtual) on the navigation equipment, e.g. buttons may be defined for “Hotels” and “Restaurants”. The codes may be verified by the advertiser using a dataform reader, for example a bar code reader associated with a point of sale system (much like systems found in retail establishments such as grocery stores). Such an implementation may become a source of revenue for the operator of the server 310 by selling access to travel and/or location-related events that occur on an operator's web site.

The appearance of a specific advertisement may be determined in a statistical sense. For example an organization can purchase a specified likelihood (e.g. 25%) that a specific advertisement will occur upon the occurrence of a predefined event. In general, the likelihood for the sum of all advertisements sold would be less than or equal to the number of total advertisements presented each occurrence of an event. Such likelihoods may be sold for fixed values or auctioned off. Further, such sales may be for fixed periods of time or a certain number of events, or a specific number of times that an advertisement is present, or the number of times that a click through occurs (where a user actually clicks on the displayed advertisement).

As used herein an event generally refers to the recognition that the search terms entered by a user or the location resulting from (or described by) such search terms has a predefined relationship to the advertisement. An event may be generated every time a map is to be displayed containing a location of interest to the advertiser. Events may also be generated based on the search terms entered by the user. For example, an event may be generated when a user searches on a specified location with (or without) the use of predetermined words, such as “Chicago” searched in combination with “restaurant” or “hotel.” An event can also be generated when a location associated with an advertisement has a predefined relationship with the location entered by the user, such as both locations are within in the same zip code, area code, jurisdiction (e.g. city, county, state, nation, etc. . . . ), associated with the same highway exit, or within a predetermined distance of each other or a third location (such as an airport or attraction).

Consider the simplified case where one advertisement appears whenever anyone searches using the words “hotel” and “Chicago.” If Hotel A pays $100 per day, their advertisement will appear with a likelihood of 50% of the time, however, for $200 per day, the advertisement will appear with a likelihood of 70% of the time. The operator of the web site may also sell an advertisement with a likelihood of only 1% for $10 per day. Alternatively, the operator may charge a fee for each click through (where a user actually clicks on the displayed advertisement). In this fashion the purchaser would select a desired likelihood and then only pay for the actual number of times their specific advertisement results in a “hit” or click through.

As an example of how such a system might be administered, consider the case where a single advertisement, also defined as an opportunity, will be shown each time an event occurs. TABLE 2 sets forth an example advertisement scenario.

N=the number of adds, or opportunities, to be presented at each event and in this case N=1

TABLE 2

| Advertiser | Fee | Likelihood |
|---|---|---|
| Hotel A | $100 | 50% |
| Hotel B | $80 | 30% |
| Hotel C | $20 | 10% |
| Hotel D | $15 | 5% |
| Hotel E | $15 | 5% |

Let the desired outcome be expressed as a vector D where the likelihood that the first add will be selected is the vector element D₁, note that element D₀ is simply a place holder with no significance:

$$D = ( \begin{matrix}{D}_{0} \\ {D}_{1} \\ {D}_{2} \\ {D}_{3} \\ {D}_{4} \\ {D}_{5}\end{matrix} )$$

Using the example illustrated in TABLE 2 the D vector becomes:

$$D = ( \begin{matrix}0 \\ 0.5 \\ 0.3 \\ 0.1 \\ 0.05 \\ 0.05\end{matrix} )$$

In this case N=1 and there is but one opportunity per event. For that opportunity the sum of the likelihood's sold is also equal to 1.0. A random number generator is used to provide a uniformly distributed random number R ranging between 0 and 1.0 (0<R≦1.0) each time that an event occurs.

The selection criteria can be set up to define a selection vector H. Table 3 illustrates a general case for the selection vector H is shown below:

TABLE 3

Hotel A if 0 < Rₙ ≦ H₁
Hotel B if H₁ < Rₙ ≦ H₂
Hotel C if H₂ < Rₙ ≦ H₃
Hotel D if H₃ < Rₙ ≦ H₄
Hotel E if H₄ < Rₙ ≦ H₅

Using the criteria set forth in Table 3, the selection vector H becomes:

$$H = ( \begin{matrix}{H}_{0} \\ {H}_{1} \\ {H}_{2} \\ {H}_{3} \\ {H}_{4} \\ {H}_{5}\end{matrix} )$$

For the example above the selection vector elements can be defined as:

H₀=0

i=1 . . . rows(D)−1

Hᵢ=Hᵢ₋₁+Dᵢ

And the H vector becomes:

$$H = ( \begin{matrix}0 \\ 0.50 \\ 0.80 \\ 0.90 \\ 0.95 \\ 1.00\end{matrix} )$$

For any given R, the advertisement selection criteria becomes as shown in TABLE 4.

TABLE 4

Hotel A if 0 < Rₙ ≦ 0.5
Hotel B if 0.5 < Rₙ ≦ 0.8
Hotel C if 0.8 < Rₙ ≦ 0.9
Hotel D if 0.9 < Rₙ ≦ 0.95
Hotel E if 0.95 < Rₙ ≦ 1.0

For a specific event the likelihood that a specific add will be selected is presented below, defining the elements of the P vector. Note that the vector value for P₁ is 0 and is only a place holder.

P₀=0

j=1 . . . rows(H)−1

Pⱼ=Hⱼ−H_{J}−1

For the single event situation, the P vector becomes:

$$P = ( \begin{matrix}0 \\ 0.5 \\ 0.3 \\ 0.1 \\ 0.05 \\ 0.05\end{matrix} )$$

A random number generator is used to output a uniformly distributed random number R ranging between 0 and 1.0 for each opportunity, that is each time that an event occurs. Using the decision criteria shown above, select an add to be presented to the viewer. In this case there is only one opportunity and one advertisement will be displayed with the sum of the likelihoods sold is also equal to 1.0.

A comparison of the actual calculated likelihoods, as shown in the P vector, are in agreement with the desired likelihoods as shown in the original D vector.

Assuming only that the random number generator is truly random, the described selection process will assure that over a large number of events, the desired likelihoods of occurrence for each advertisement will be achieved. Also by using a random number generator, no specific advertisement will have any correlation with the situation that caused the event to occur.

If the sum of the advertisement likelihoods is more than the number of advertisements to be presented, then one of the advertisements will not be appropriately represented. It is up to the operator of the server to ensure that an excess of likelihoods is not sold. The reverse situation, where the sum of the likelihoods are less than the number of advertisements to be shown, may be addressed by assigning the unused likelihood function to an unassigned category. For example, assuming that advertisements are sold as set forth in TABLE 5:

TABLE 5

| Advertiser | Fee | Likelihood |
|---|---|---|
| Hotel A | $100 | 50% |
| Hotel B | $80 | 30% |
| Hotel C | $20 | 10% |
| Hotel D | $15 | 5% |

The selection criteria are defined as illustrated in TABLE 6.

TABLE 6

Hotel A if 0 < Rₙ ≦ 0.5
Hotel B if 0.5 < Rₙ ≦ 0.8
Hotel C if 0.8 < Rₙ ≦ 0.9
Hotel D if 0.9 < Rₙ ≦ 0.95
Unassigned if 0.95 < Rₙ ≦ 1.0

During the selection process if the R falls between 0.95 and 1.00 another random number is generated. Continue this process until the random number generated results in a selection to any other advertiser except “Unassigned”. The effect is to increase the likelihood of all the valid advertisers.

By way of further example, let us now assume that two advertisements will be displayed with each event. Thus for each event, there are now two opportunities for success, and the sum of the likelihoods has to be equal to or less than 2. In this example, we will use nine hotels seeking advertisement placement, wherein each hotel has purchased the following likelihoods illustrated in TABLE 7.

TABLE 7

| Advertiser | Fee | Likelihood |
|---|---|---|
| Hotel A | $100 | 50% |
| Hotel B | $80 | 30% |
| Hotel C | $20 | 10% |
| Hotel D | $15 | 5% |
| Hotel E | $15 | 5% |
| Hotel F | $200 | 70% |
| Hotel G | $20 | 20% |
| Hotel H | $20 | 5% |
| Hotel I | $20 | 5% |

Thus, Hotel A pays $100 for a likelihood of 50% that its advertisement will appear as one of the two advertisements for each event. This, of course also leaves open the possibility of charging an extra placement fee to ensure that, if selected, an advertisement will appear higher on the displayed list of ads.

For this new case N=2 and for each opportunity the sum of the probabilities that an add will be selected is also equal to 1.0. Be sensitive however that the probability that an add will be selected for a specific opportunity, that is for example the first opportunity, is different from the likelihood that an add will be selected in either the first or second opportunities. Again use a random number generator to develop a uniformly distributed random number R ranging between 0 and 1.0 (0<R≦1.0) each time that an opportunity (i.e. add position) is to be filled.

For this case, the selection points are more complex to develop because each advertiser has two chances or opportunities to be successfully selected, that is there are two add positions, and this will result in a modification of the selection criteria. For each event, all of the advertisements will be appropriately sold if the sum of all the probabilities is less than or equal to 2.0. We can not sell more than 100% of the available advertising space.

Regardless of how the selection criteria are set up, the desired outcome is shown in the D vector below:

$$D = ( \begin{matrix}0 \\ 0.50 \\ 0.30 \\ 0.10 \\ 0.05 \\ 0.05 \\ 0.70 \\ 0.20 \\ 0.05 \\ 0.05\end{matrix} )$$

Note that:

$$Sum = {\sum }_{n = 0}^{rows ( D ) - 1} {D}_{n}$$

$$Sum = 2.0$$

which is equal to or less than 2.0, thus this combination is acceptable

As above, the selection criteria can be as defined below in Table 8.

TABLE 8

Hotel A if H₀ < Rₙ ≦ H₁
Hotel B if H₁ < Rₙ ≦ H₂
Hotel C if H₂ < Rₙ ≦ H₃
Hotel D if H₃ < Rₙ ≦ H₄
Hotel E if H₄ < Rₙ ≦ H₅
Hotel F if H₅ < Rₙ ≦ H₆
Hotel G if H₆ < Rₙ ≦ H₇
Hotel H if H₇ < Rₙ ≦ H₈
Hotel E if H₈ < Rₙ ≦ H₉

This can be used as the basis for an iterative technique to define the appropriate selection criteria. The D vector can now be used to develop the first approximation for the H vector. As a first estimate, let the H vector element values be as defined below:

$${H}_{0} = 0$$

$$i = 1 … rows ( D ) - 1$$

$${H}_{i} = {H}_{i - 1} + \frac{{D}_{i}}{2}$$

In the case above, the initial selection points are shown in the vector H1 below:

$$N = 2$$

$$H 1 = ( \begin{matrix}0 \\ 0.250 \\ 0.400 \\ 0.450 \\ 0.475 \\ 0.500 \\ 0.850 \\ 0.950 \\ 0.975 \\ 1.000\end{matrix} )$$

For a specific event the likelihood that a specific add will be selected for either the first position or the second position can be explicitly developed and is presented below, defining the elements of the P vector. Note that the vector value for P₁ is 0 and is only a place holder.

$${P}_{0} = 0$$

$$j = 1 … rows ( H ) - 1$$

$${P}_{j} = ( {H}_{j} - {H}_{j} - 1 ) \cdot ( 1 - \frac{{H}_{j} - {H}_{j - 1}}{1 - ( {H}_{j} - {H}_{j - 1} )} + {\sum }_{ij = 1}^{rows ( H ) - 1} \frac{{H}_{jj} - {H}_{jj - 1}}{1 - ( {H}_{jj} - {H}_{jj - 1} )} )$$

Now using the H1 vector as a starting point, the values of H can be manually adjusted until the calculated likelihoods, as shown in the P vector, are in agreement with the desired likelihoods as shown in the D vector. To assist in this iterative process, an error vector, Error, is defined. The calculated results are expressed in their transposed form to allow a more economical presentation format.

Error=P−D

H^{T}=(0.0000 0.2400 0.3735 0.4160 0.4370 0.4580 0.8710 0.9580 0.9790 1.0000)

D^{T}=(0.0000 0.5000 0.3000 0.1000 0.0500 0.0500 0.7000 0.2000 0.0500 0.0500)

p^{T}=(0.0000 0.4999 0.2997 0.1001 0.0499 0.0499 0.7002 0.2004 0.0499 0.0499)

Error^{T}=(0.0000 −0.0001 −0.0003 0.0001 −0.0001 −0.0001 0.0002 0.0004 −0.0001 −0.0001)

Ideally all the elements of the Error vector will converge on 0 as the appropriate H are developed. The additional metric SumE defined below can assist in this process. SumE will also converge to 0 as the appropriate H values are developed:

$$SumE = {\sum }_{n = 0}^{rows ( P ) - 1} \vert {Error}_{n} \vert$$

$$SumE = 0.0013$$

At this point the appropriate selection criteria have been defined with the H vector for the two opportunity example defined above.

The selection process for the case of two opportunities becomes as follows:
For the first opportunity, select a random number in the range 0<R1≦1.0
compare R1 to the decision criteria of TABLE 8 utilizing the associated optimized selection values defined in the H vector and selection a first advertisement.
for the second opportunity generate a second random number in the range of 0<R2≦1.0
compare R2 to the decision criteria of TABLE 8 utilizing the associated optimized selection values defined in the H vector and select a second advertisement
if the second advertisement is the same as the first advertisement, generate a new random number R2 and continue generating a new random number R2 until a second advertisement is selected that is different from the first advertisement.
The first and second advertisements have now been appropriately selected.

A processes has been outline that can be used to select either a single advertisement or two advertisements according to a statistical selection process thus demonstrating the functionality of the process. Clearly the process can be extrapolated to 3, 4 or more advertisements utilizing the statistical process outline in the forgoing text. The organization purchasing the advertising space might pay either based on a likelihood or probability that an advertisement will be presented. Alternately the organization purchasing the advertising space might pay a fee each time their advertisement is selected. For example they might pay $0.04 each time their advertisement is selected. In either case the organization purchasing the advertisement might pay either ahead of time, or after a period time.

What is claimed is:

1. A navigation system comprising:
a map server that provides a client with a map of a destination, the map having an at least one dataform containing an indication of the destination;
a navigator including a GPS receiver receiving signals from one or more satellites, a dataform reader that extracts the indication of the destination from the at least one dataform, and a processor that provides turn by turn directions to the destination.

2. The navigator, as set forth in claim 1, wherein the at least one dataform comprises at least one barcode.

3. The navigator, as set forth in claim 1, wherein the map server additionally identifies advertisements associated with the destination and wherein addresses associated with the identified advertisements are encoded in the at least one dataform.

4. The navigator, as set forth in claim 3, wherein the advertisements are identified based on a distance relationship with the destination.

5. The navigator, as set forth in claim 3, wherein the advertisements are identified based on at least one of an area code and a zip code associated with the advertisement.

6. A navigator, as set forth in claim 3, wherein the advertisements are identified based on a likelihood associated with each advertisement.

7. A navigator, as set forth in claim 6, wherein a likelihood is purchased by an advertiser placing the advertisment.

8. A method comprising:
receiving an indication of a destination;
generating a map of a selected destination,
generating at least one dataform having information associated with the destination,
displaying the map with the first dataform.

9. A method, as set forth in claim 8, further comprising:
printing the map with the first dataform;
scanning the dataform with a dataform reader to verify the information encoded by the dataform.

10. A method of using a navigator, the method comprising:
scanning a dataform printed on a map of a destination with a dataform reader associated with the navigator;
extracting a destination from the scanned dataform;
determining a route to the destination; and
providing a user turn-by-turn directions to the destination.

11. A method, as set forth in claim 10, wherein the step of scanning comprises scanning a two dimension barcodes.

12. A method comprising:
identifying a destination based on user input;
identifying at least one advertisement associated with the destination; and
printing a map of a destination with at least one dataform containing an indication of the destination and the at least one advertisement.

13. A method, as set forth in claim 12, wherein an advertisement comprises an indication of a location associated with the advertisement.

14. A method, as set froth in claim 12, wherein an advertisement comprises a code that entitles the bearer to some benefit.

15. A method, as set froth in claim 12, wherein the at least one dataform comprises at least one barcode.

16. A method, as set forth in claim 12, wherein the at least one advertisement is identified based on a likelihood associated with each advertisement.

17. A method, as set forth in claim 12, wherein the at least one advertisement is identified based on a proximity of a location associated with the advertisements to the destination.

18. A method, as set forth in claim 12, wherein the at least one advertisement is identified based on a proximity of a location associated with the advertisements to the destination and a likelihood associated with each advertisement.

19. A method, as set forth in claim 12, further comprising:
selling to a plurality of advertisers a likelihood that an advertisement will be associated with a map in which a destination selected by the advertiser appears.

20. A method of advertising on a web page, the method comprising:
associating a likelihood to each of a plurality of advertisements, each advertisement having an associated location;
receiving from a user a search request having a location component;
identifying a set of advertisements satisfying a predetermined relationship with the search request;
using the likelihood associated with each advertisement in the set of advertisements to select one or more of the advertisements in the set of advertisements; and
providing, to the user, the selected advertisements in association with the results of the search request.

21. The method, as set forth in claim 20, wherein the advertisement comprises a dataform containing a location associated with a subject matter of the advertisement.

22. The method, as set forth in claim 20, wherein the predetermined relationship is a distance relationship.

23. The method, as set forth in claim 20, wherein the predetermined relationship is satisfied when the associated location of an advertisement shares an area code with the location component of the search request.

24. The method, as set forth in claim 20, wherein the predetermined relationship is satisfied when the associated location of an advertisement shares a zip code with the location component of the search request.

25. The method, as set forth in claim 20, wherein the predetermined relationship is satisfied when the associated location of an advertisement shares a jurisdiction with the location component of the search request.
